(19) United States
(12) Patent Application Publication
(10) Pub. No.: US 2013/0030761 A1
(43) Pub. Date: Jan. 31, 2013

(54) STATISTICALLY-BASED ANOMALY DETECTION IN UTILITY CLOUDS

(71) Applicants: Choudur LAKSHMINARAYAN, Austin, TX (US); Krishnamurthy Viswanathan, Mountain View, CA (US); Chengwei Wang, Atlanta, GA (US); Vanish Talwar, Campbell, CA (US)

(72) Inventors: Choudur LAKSHMINARAYAN, Austin, TX (US); Krishnamurthy Viswanathan, Mountain View, CA (US); Chengwei Wang, Atlanta, GA (US); Vanish Talwar, Campbell, CA (US)

(21) Appl. No.: 13/194,798

(22) Filed: Jul. 29, 2011

(51) Int. Cl. G06F 17/18

(52) U.S. Cl. 702/179

(57) ABSTRACT

Systems and methods for detecting anomalies in a large scale and cloud datacenter are disclosed. Anomaly detection is performed in an automated, statistical-based manner by using a parametric Gini coefficient technique or a non-parametric Tukey technique. In the parametric Gini coefficient technique, sample data is collected within a look-back window. The sample data is normalized to generate normalized data, which is binned into a plurality of bins defined by bin indices. A Gini coefficient and a threshold are calculated for the look-back window and the Gini coefficient is compared to the threshold to detect an anomaly in the sample data. In the non-parametric Tukey technique, collected sample data is divided into quartiles and compared to adjustable Tukey thresholds to detect anomalies in the sample data.

### BACKGROUND

Large scale and cloud datacenters are becoming increasingly popular, as they offer computing resources for multiple tenants at a very low cost on an attractive pay-as-you-go model. Many small and medium businesses are turning to these cloud datacenters, not only for occasional large computational tasks, but also for their IT jobs. This helps them eliminate the expensive, and often very complex, task of building and maintaining their own infrastructure. To fully realize the benefits of resource sharing, these cloud datacenters must scale to huge sizes. The larger the number of tenants, and the larger the number of virtual machines and physical servers, the better the chances for higher resource efficiencies and cost savings. Increasing the scale alone, however, cannot fully minimize the total cost as a great deal of expensive human effort is required to configure the equipment, to operate it optimally, and to provide ongoing management and maintenance. A good fraction of these costs reflect the complexity of managing system behavior, including anomalous system behavior that may arise in the course of system operations.

The online detection of anomalous system behavior caused by operator errors, hardware/software failures, resource over-/under-provisioning, and similar causes is a vital element of system operations in these large scale and cloud datacenters. Given their ever-increasing scale coupled with the increasing complexity of software, applications, and workload, patterns, anomaly detection techniques in large scale and cloud datacenters must be scalable to the large amount of monitoring data (i.e., metrics) and the large number of components. For example, if 10 million cores are used in a large scale or cloud datacenter with 10 virtual machines per node, the total amount of metrics generated can reach exascale, 10¹⁸. These metrics may include Central Processing Unit (“CPU”) cycles, memory usage, bandwidth usage, and any other suitable metrics.

The anomalous detection techniques currently used in industry are often ad hoc or specific to certain applications, and they may require extensive tuning for sensitivity and/or to avoid high rates of false alarms. An issue with threshold-based methods, for instance, is that they detect anomalies after they occur instead of noticing their impeding arrival. Further, potentially high false alarm rates can result from monitoring only individual rather than combination of metrics. Other recently developed techniques can be unresponsive due to their use of complex statistical techniques and/or may suffer from a relative lack of scalability because they mine immense amounts of non-aggregated metric data. In addition, their analyses often require prior knowledge about applications, service implementation, or request semantics.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates a schematic diagram of an example datacenter in accordance with various embodiments;

FIG. 2 illustrates a diagram of an example cloud datacenter represented as a tree:

FIG. 3 illustrates an example core for use with the datacenter of FIG. 1 and the cloud of FIG. 2;

FIG. 4 illustrates a schematic diagram of a statistical-based anomaly detection framework for a large scale and cloud datacenter in accordance with various embodiments;

FIG. 5 illustrates a block diagram of a statistical-based anomaly detection module of FIG. 4 based on a parametric statistical technique;

FIG. 6 is a flowchart for implementing the anomaly detection module of FIG. 5;

FIG. 7 illustrates a block diagram of a statistical-based anomaly detection module of FIG. 4 based on a non-parametric statistical technique; and

FIG. 8 is a flowchart for implementing the anomaly detection module of FIG. 7.

### DETAILED DESCRIPTION

Anomaly detection techniques for large scale and cloud datacenters are disclosed. The anomaly detection techniques are able to analyze multiple metrics at different levels of abstraction (i.e., hardware, software, system, middleware, or applications) without prior knowledge of workload behavior and datacenter topology. The metrics may include Central Processing Unit (“CPU”) cycles, memory usage, bandwidth usage, operating system (“OS”) metrics, application metrics, platform metrics, service metrics and any other suitable metric.

The datacenter may be organized horizontally in terms of components that include cores, sockets, node enclosures, racks, and containers. Further, each physical core may have a plurality of software applications organized vertically in terms of a software stack that includes components such as applications, virtual machines (“VMs”), OSs, and hypervisors or virtual machine monitors (“VMMs”). Each one of these components may generate an enormous amount of metric data regarding their performance. These components are also dynamic, as they can become active or inactive on an ad hoc basis depending upon user needs. For example, heterogeneous applications such as map-reduce, social networking, e-commerce solutions, multi-tier web applications, and video streaming may all be executed on an ad hoc basis and have vastly different workload and request patterns. The online management of VMs and power adds to this dynamism.

In one embodiment, anomaly detection is performed with a parametric Gini-coefficient based technique. As generally described herein, a Gini coefficient is a measure of statistical dispersion or inequality of a distribution. Each node (physical or virtual) in the datacenter runs a Gini-based anomaly detector that takes raw monitoring data (e.g., OS, application, and platform metrics) and transforms the data into a series of Gini coefficients. Anomaly detection is then applied on the series of Gini coefficients. Gini coefficients from multiple nodes may be aggregated together in a hierarchical manner to detect anomalies on the aggregated data.

In another embodiment, anomaly detection is performed with a non-parametric Tukey based technique that determines outliers in a set of data. Data is divided into ranges and thresholds are constructed to flag anomalous data. The thresholds may be adjusted by a user depending on the metric being monitored. This Tukey based technique is lightweight and improves over standard Gaussian assumptions in terms of performance while exhibiting good accuracy and low false alarm rates.

It is appreciated that, in the following description, numerous specific details are set forth to provide a thorough understanding of the embodiments. However, it is appreciated that the embodiments may be practiced without limitation to these specific details. In other instances, well known methods and structures may not be described in detail to avoid unnecessarily obscuring the description of the embodiments. Also, the embodiments may be used in combination with each other.

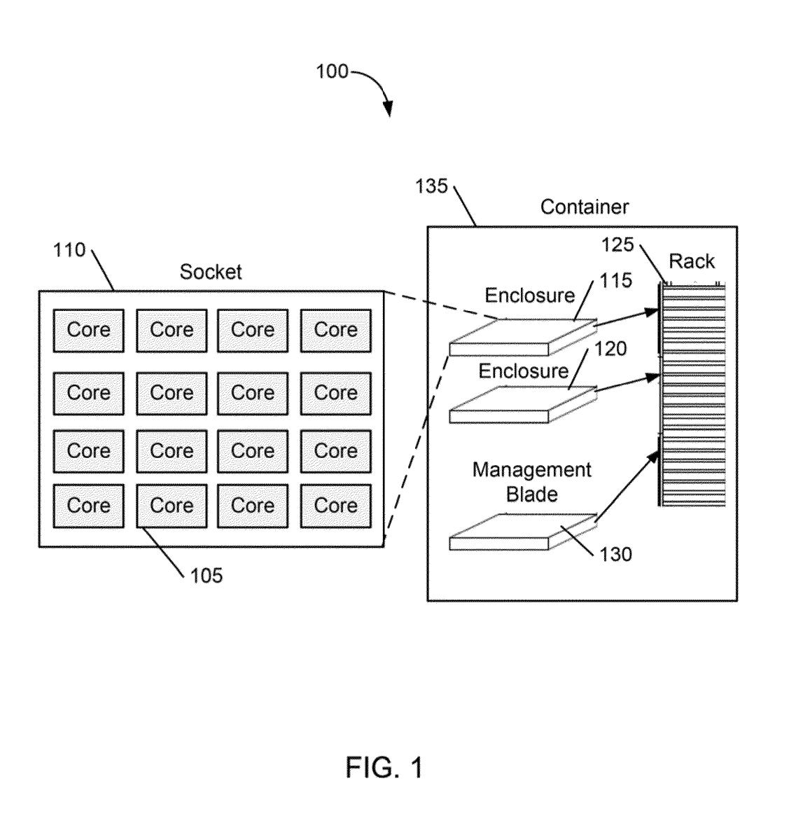

Referring now to FIG. 1, a schematic diagram of an example datacenter is described. Datacenter 100 may be composed of multiple components that include cores, sockets, node enclosures, racks, and containers, such as, for example, core 105, socket 110, node enclosures 115-120, and rack 125. Core 105 resides, along with other cores, in the socket 110. The socket 110 is, in turn, part of an enclosure 115. The enclosures 115-120 and management blade 130 are part of the rack 125. The rack 125 is part of a container 135. It is appreciated that a large scale and cloud datacenter may be composed of multiple such datacenters 100, with multiple components.

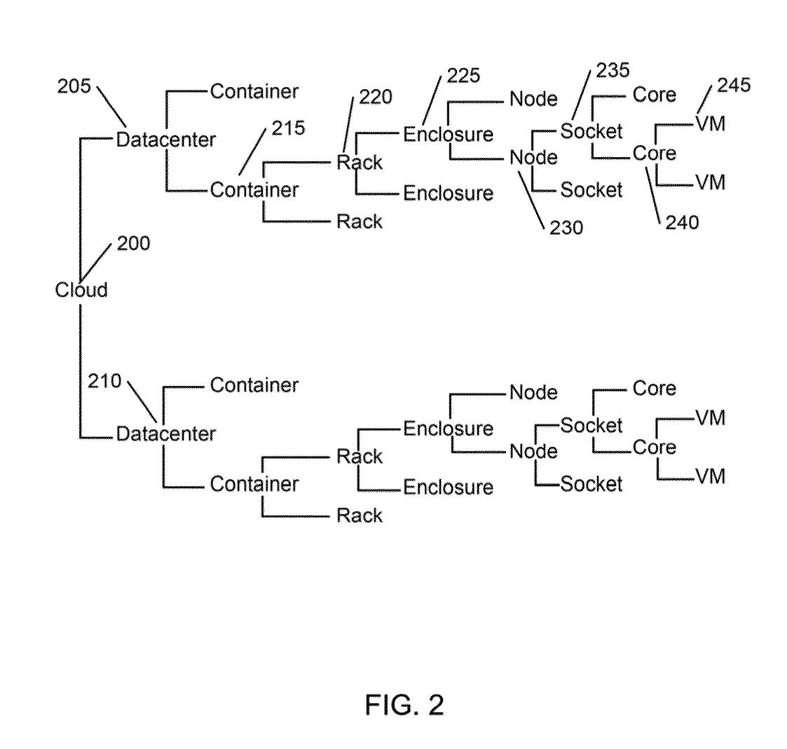

For example, FIG. 2 shows a diagram of an example cloud datacenter 200 represented as a tree. Cloud datacenter 200 may have multiple datacenters, such as datacenters 205-210. Each datacenter may be in turn composed of multiple containers, racks, enclosures, nodes, sockets, cores, and VMs. For example, datacenter 205 has a container 215 that includes multiple racks, such as rack 220. Rack 220 has multiple enclosures, such as enclosure 225. Enclosure 225 has multiple nodes, such as node 230. Node 230 is composed of multiple sockets, such as socket 235, which in turn, has multiple cores, e.g., core 240. Each core may have multiple VMs, such as VM 245 in core 240.

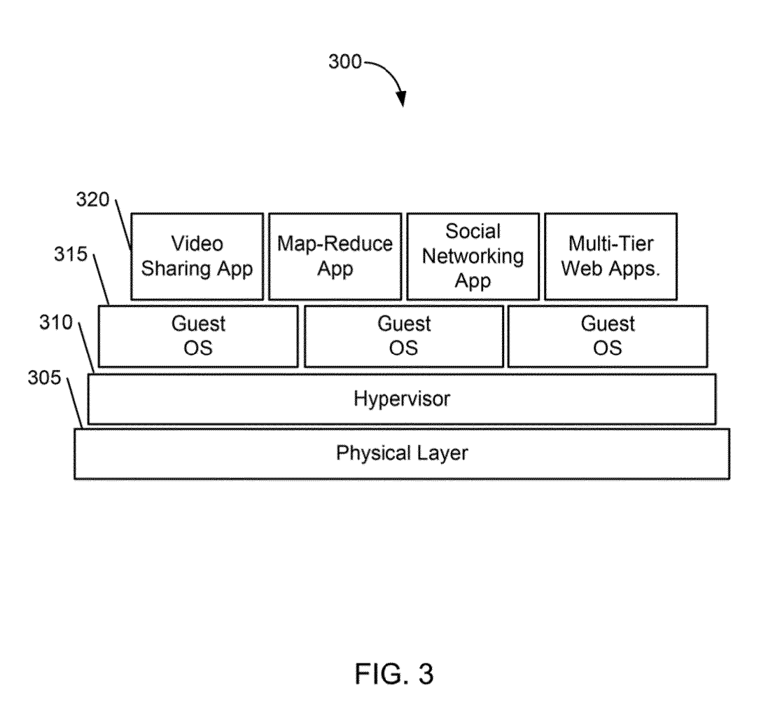

An example core for use with datacenter 100 and cloud 200 is shown in FIG. 3. Core 300 has a physical layer 305 and a hypervisor 310. Residing on top of the hypervisor 310 is a plurality of guest OSs encapsulated as a VM 315. These guest OSs may be used to manage one or more applications 320 such as, for example, a video-sharing application, a map-reduce application, a social networking applications, or multi-tier web applications.

The sheer magnitude of a cloud datacenter (e.g., cloud datacenter 200) requires that anomaly detection techniques handle multiple metrics at the different levels of abstraction (i.e., hardware, software, system, middleware, or applications) present at the datacenter. Furthermore, anomaly detection techniques for a large scale and cloud datacenter also need to accommodate the workload characteristics and patterns including day of the week, and hour of the day patterns of workload behavior. The anomaly detection techniques also need to be aware of and address the dynamic nature of data center systems and applications, including dealing with application arrivals and departures, changes in workload, and system-level load balancing though, say, virtual machine migration. In addition, the anomaly detection techniques must exhibit good accuracy and low false alarm for meaningful results.

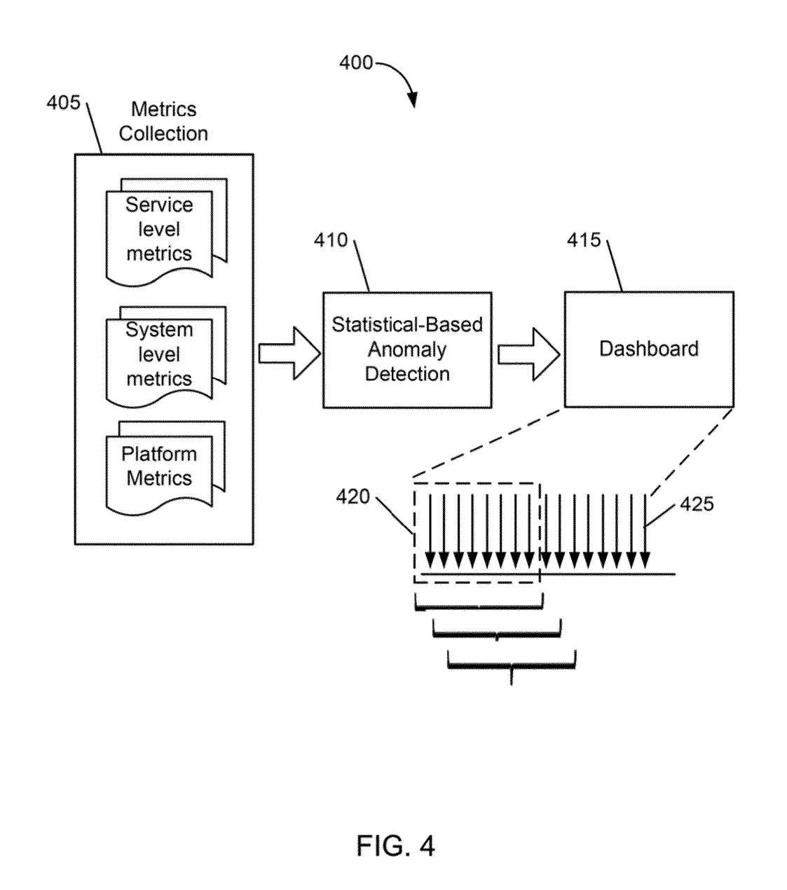

Referring now to FIG. 4, a schematic diagram of a statistical-based anomaly detection framework for a large scale and cloud datacenter is described. Statistical-based anomaly detection framework 400 includes a metrics collection module 405, a statistical-based anomaly detection module 410, and a dashboard module 415. Metrics collection module 405 collects raw metric and monitoring data, such as platform metrics, system level metrics, and service level metrics, among others. The collected metrics are used as input to the statistical-based anomaly detection module 410, which detects anomalies in the input data. As described in more detail below, the statistical-based anomaly detection module 410 may be based on a parametric statistical technique or a non-parametric statistic technique. The input data may be visualized in the dashboard module 415 that is used to display a look-back window 420 reflecting a processed and displayed series of metric samples 425. The look-back window 420 may slide from sample to sample during the monitoring process and is used to collect samples for a given type of metric (e.g., CPU cycles, memory usage, etc.)

As appreciated by one of skill in the art, the statistical-based anomaly detection framework 400 may be implemented in a distributed manner in the datacenter, such that each node (physical or virtual) may run an anomaly detection module 410. The anomaly detection from multiple nodes may be aggregated together in a hierarchical manner to detect anomalies on the aggregated data.

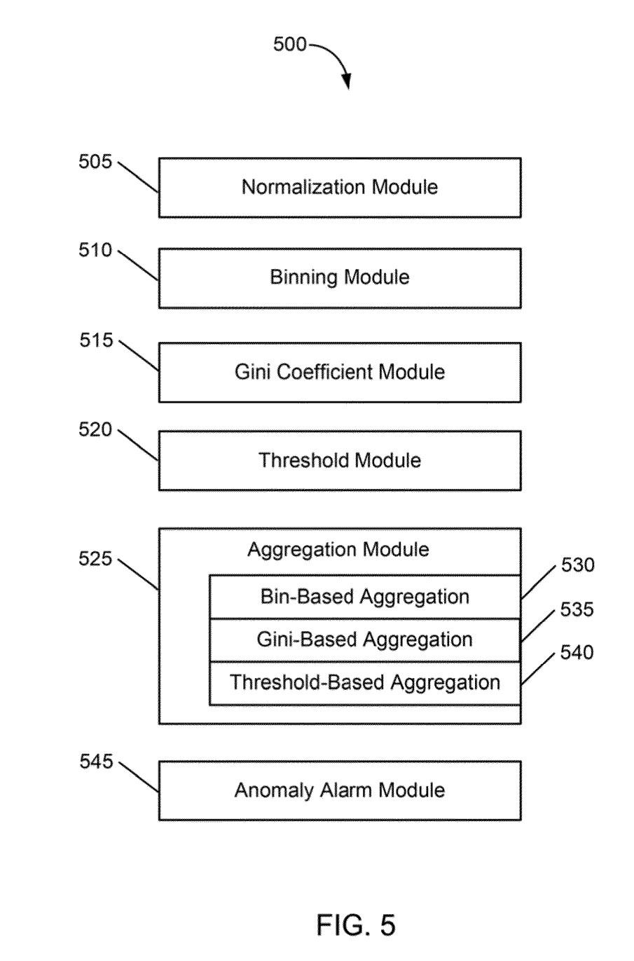

Referring now to FIG. 5, a block diagram of a statistical-based anomaly detection module of FIG. 4 based on a parametric statistical technique is described. Anomaly detection module 500 detects anomalies in collected metrics using a parametric Gini-coefficient based technique. The parametric-based anomaly detection module 500 is implemented with a normalization module 505, a binning module 510, a Gini coefficient module 515, a threshold module 520, an aggregation module 525, and an anomaly alarm module 545.

The normalization module 505 receives metrics from a metrics collection module (e.g., metrics collection module 405 shown in FIG. 4) and normalizes the collected metrics for a given look-back window (which may be displayed in a dashboard module such as dashboard module 415). The normalized data is then input into the binning module 510, which divides the data into indexed bins and transforms the binned indices into a single vector for each sample. This vector is then defined as a random variable used to calculate a Gini coefficient value for the look-back window in the Gini coefficient module 515. A threshold for comparison with the Gini coefficient is calculated in the threshold module 520.

It is appreciated that normalization module 505, the binning module 510, the Gini coefficient module 515, and the threshold module 520 are implemented to process data for a single computational node in a large scale and cloud datacenter. To detect anomalies in the entire datacenter requires the data from multiple nodes to be evaluated. That is, the anomaly detection needs to be aggregated along the hierarchy in the datacenter (e.g., the hierarchy illustrated in FIG. 2) so that anomalies may be detected for multiple nodes.

The anomaly detection aggregation is implemented in the aggregation module 525. In various embodiments, the aggregation may be performed in different ways, such as, for example, in a bin-based aggregation 530, a Gini-based aggregation 535, or a threshold-based aggregation 540. In the bin-based aggregation 530, the aggregation module 525 combines the information from the binning module 510 running in each node. In the Gini-based aggregation 535, the aggregation module 525 combines the Gini coefficients from the multiple nodes. And in the threshold-based aggregation 540, the aggregation module 525 combines the results for the threshold comparisons performed in the multiple nodes.

The anomaly alarm module 545 generates an alarm when the Gini coefficient for the given look-back window exceeds the threshold. The alarm and the detected anomalies may be indicated to a user in the dashboard module (e.g., dashboard module 415).

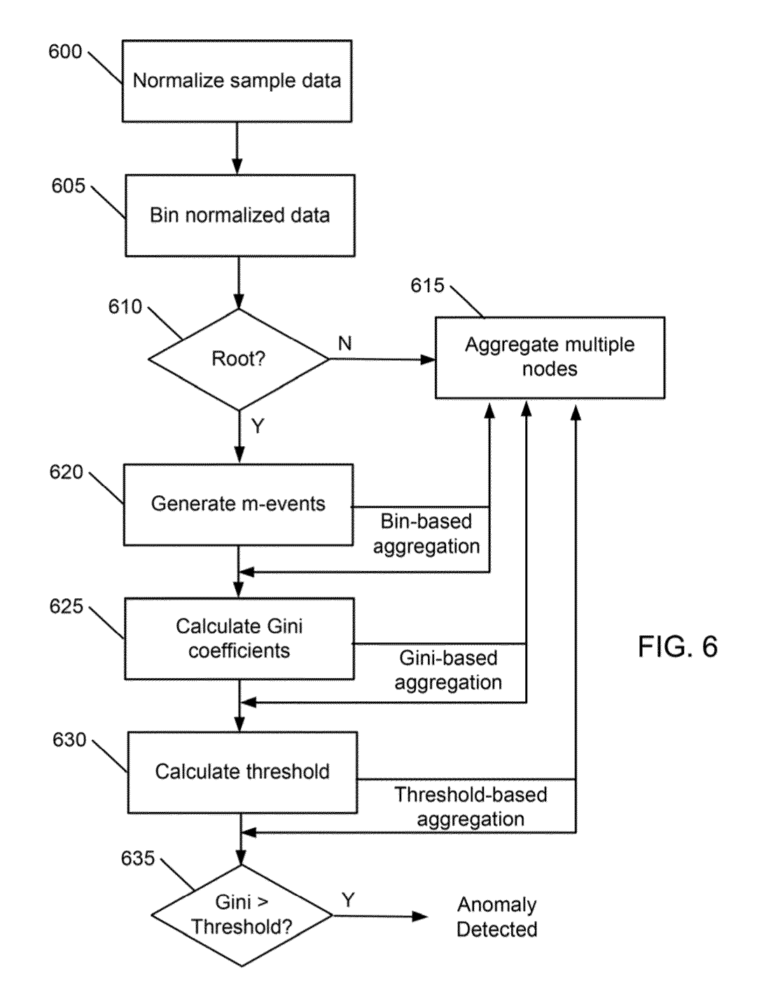

The operation of the anomaly detection module 500 is illustrated in more detail in a flow chart shown in FIG. 6. First, the metrics collected within a look-back window (e.g., look-back window 420) for a given node is input into the normalization module 505 (600). A metric value v, within the look-back window is transformed to a normalized value vᵢ^{′} as follows:

$${v}_{i}^{′} = \frac{{v}_{i} - μ}{σ} \qquad ( Eq . 1 )$$

where μ is the mean and σ is the standard deviation of the collected metrics within the look-back window and i represents the metric type.

After normalization, data binning is performed (605) in the binning module 510 by hashing each normalized sample value into a bin. A value range [0,r] is predefined and split into in equal-sized bins indexed from 0 to m−1. Another bin indexed m is defined to capture values that are outside the value range (i.e., greater than r). Each of the normalized values is put into the in bin if its value is greater than r, or into a bin with index given by the floor of the sample value divided by (r/m) otherwise, that is:

$${B}_{i} = ⌊ \frac{{v}_{i}^{′}}{( \frac{r}{m} )} ⌋ \qquad ( Eq . 2 )$$

where Bᵢ is the bin index for the normalized sample value vᵢ^{′}. Both m and r are pre-determined statistically and can be configurable parameters.

It is appreciated that if the node for which the metrics were collected, normalized, and binned is not a root node (610), that is, a leaf in the datacenter hierarchy tree shown in FIG. 2, aggregation with other nodes may be performed to detect anomalies across the nodes (615). The aggregation may be a bin-based aggregation 530, a Gini-based aggregation 540, or a threshold-based aggregation 545, as described in more detail below.

Once the samples of the collected metrics within the look-back window are pre-processed and transformed into a series of bin index numbers, an m-event is generated that includes the transformed values from multiple metric types into a single vector for each time instance. More specifically, an m-event Eₜ of a single machine at time t can be formulated with the following vector description:

Eₜ= [symbol] Bₜ₁,Bₜ₂, . . . ,Bₜₖ

[symbol]

where Bₜⱼ is the bin index number for the j metric at time t for a total of k metrics. Two m-events Eₐ and E_{b} have the same vector value if they are created on the same machine and Bₐⱼ=B_{bj}, ∀jε[1,k]. It is appreciated that each node in the datacenter may send its m-event with bin indices to the aggregation module 525 for bin-based aggregation 530. The aggregation module 525 combines the bin indices to form higher dimensional m-events and calculate the Gini coefficient and threshold based on those m-events.

The calculation of a Gini coefficient starts by defining a random variable E as an observation of m-events within a look-back window with a size of, say, n samples. The outcomes of this random variable E are v m-event vector values {e₁, e₂, . . . , eᵥ}, where v<n when there are m-events with the same value in the n samples. For each of these v values, a count of the number of occurrences of that eᵢ in the n samples is kept. This is designated as n, and represents the number of m-events having the vector value eᵢ.

A Gini coefficient G for the look-back window is then calculated (625) as follows:

$$G ( E ) = 1 - {\sum }_{i = 1}^{v} {( \frac{{n}_{i}}{n} )}^{2} \qquad ( Eq . 4 )$$

It is appreciated that each node in the datacenter may send its Gini coefficient to the aggregation module 525 for Gini-based aggregation 535. The aggregation module 525 then creates an m-event vector with k elements. Element i of this vector is the bin index number associated with the Gini coefficient value for the i^{th} node. Ah aggregated Gini coefficient is then computed as the Gini coefficient of this m-event vector within the look-hack window. Anomaly detection can then be checked for this aggregated value.

To detect anomalies within the look-back window, the Gini coefficient above needs to be compared to a threshold. In one embodiment, the threshold T is a Gini standard deviation dependent threshold and can be calculated (630) as follows:

$$T = {μ}_{G} \pm \frac{3 {σ}_{G}}{\sqrt{v}} \qquad ( Eq . 5 )$$

where μ_{G} is the average Gini coefficient value over all sliding look-back windows and calculated asymptotically from the look-back window using the statistical Cramer's Delta method, and σ_{G} is the estimated standard deviation of the Gini coefficient obtained by also applying the Delta method, which uses a Taylor series approximation of the Gini coefficient and obtains approximations to standard deviations of intractable functions such as the Gini coefficient function in Eq. 4.

It is appreciated that this threshold computation, by using the estimated standard deviation σ_{G}, delivers an estimate of the variability of the Gini coefficient. It is this variability that allows anomalies to be detected. If the Gini coefficient G(E) exceeds this threshold value T (either G(E)>T or G(E)<−T), then an anomaly alarm is raised (635) and notified to the user or operator monitoring the datacenter (such as, for example, by displaying the alarm and the detected anomaly in the dashboard module 415).

It is appreciated that a threshold-based aggregation 540 may also be implemented to aggregate anomaly detection for multiple nodes. In this case, anomalies are detected if any one of the nodes has an anomaly alarm.

It is further appreciated that the above parametric-based anomaly detection technique using the Gini coefficient and a Gini standard deviation dependent threshold is computationally lightweight. In addition, the Gini standard deviation threshold enables an entirely new automated approach to anomaly detection that can be systematically applied to multiple metrics across multiple nodes in large scale and cloud datacenters. The anomaly detection can be applied numerous times to metrics collected within sliding look-back windows.

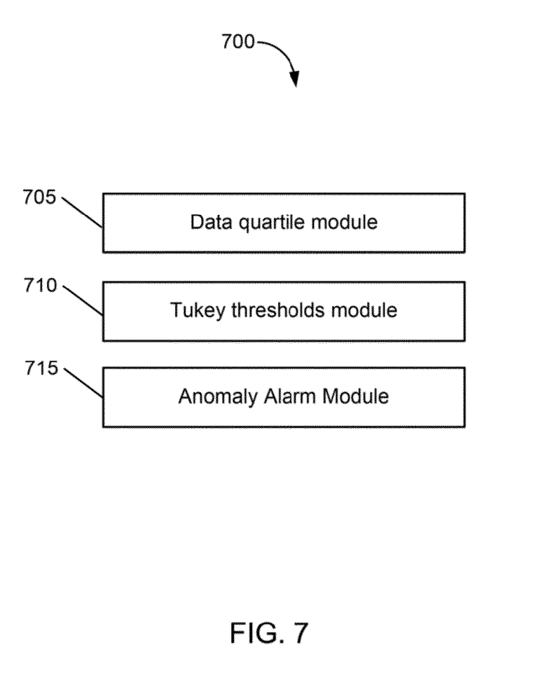

Referring now to FIG. 7, a block diagram of a statistical-based anomaly detection module of FIG. 4 based on a non-parametric statistical technique is described. Anomaly detection module 700 detects anomalies in collected metrics using a non-parametric Tukey-based technique. Similar to Gaussian techniques for anomaly detection, the Tukey technique constructs a lower threshold and an upper threshold to flag data as anomalous. However, the Tukey technique does not make any distributional assumptions about the data as is the case with the Gaussian approaches.

The non-parametric anomaly detection module 700 is implemented with a data quartile module 705, a Tukey thresholds module 710, and a anomaly alarm module 715. The data quartile module 705 divides the collected metrics into quartiles for analysis. The Tukey thresholds module 700 defines Tukey thresholds for comparison with the quartile data. The comparisons are performed in the anomaly alarm module 715.

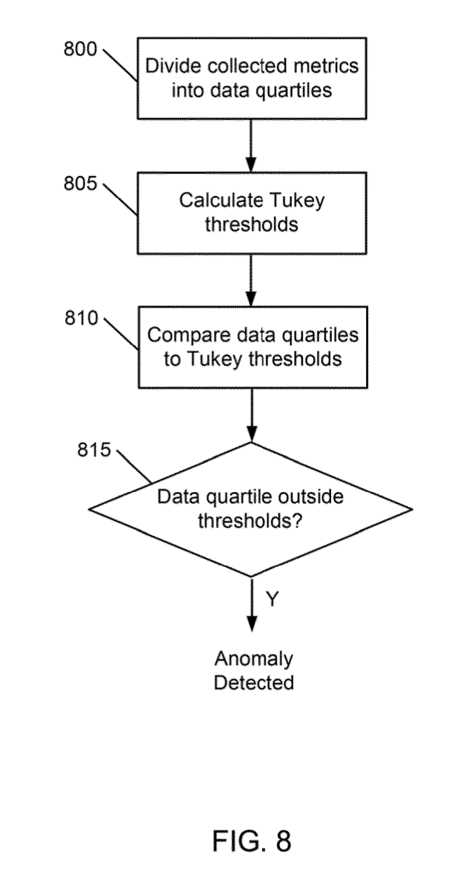

The operation of the anomaly detection module 700 is illustrated in more detail in a flow chart shown in FIG. 8. First, a set of random observation samples of a metric collected within a look-back window is arranged in ascending order from the smallest to the largest observation. The ordered data is then broken up into quartiles (800), the boundary of each is defined by Q₁, Q₂, and Q₃ and called the first quartile, the second quartile, and the third quartile, respectively. The difference |Q₃−Q₁| is referred to as the inter-quartile range.

Next, two Tukey thresholds are defined, a lower threshold T₁ and an upper threshold Tₙ:

T₁=Q₁−k|Q₃−Q₁| (Eq. 6)

Tₙ=Q₃+k|Q₃+k|Q₃−Q₁ (Eq. 7)

where k is an adjustable tuning parameter that controls the size of the lower and upper thresholds. It is appreciated that k can be metric-dependent and adjusted by a user based on the distribution of the metric. A typical range for k may be from 1.5 to 4.5.

The data in the quartiles is compared to the lower and upper Tukey thresholds (810) so that any data outside the threshold range (815) triggers an anomaly detection alarm. Given a sample x of a given metric in the look-back window, an anomaly is detected (on the upper end of the data range) when:

Q₃(k/2)Q₃−Q₁|≧x≧(k/2)|Q₃−Q₁| (Eq. 8)

or (on the lower end, of the data range) when:

Q₁−(k/2)|Q₃−Q₁|≧x≧Q₁−(k/2)|Q₃−Q₁| (Eq. 9)

It is appreciated that this non-parametric anomaly detection approach based on the Tukey technique is also computational lightweight. The Tukey thresholds may be metric-dependent and computed a priori, thus improving the performance and efficiency of automated anomaly detection in large scale and cloud datacenters. Both the parametric (i.e., Gini-based) and the non-parametric (i.e., Tukey-based) anomaly detection approaches discussed herein provide good responsiveness, are applicable across multiple metrics, and have good scalability properties.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for detecting anomalies in a large scale and cloud datacenter, the method comprising:
collecting sample data within a look-back window;
normalizing the sample data to generate normalized data;
binning the normalized data into a plurality of bins defined by bin indices;
calculating a Gini coefficient for the look-back window;
calculating a Gini standard deviation dependent threshold; and
comparing the Gini coefficient to the Gini standard deviation dependent threshold to detect an anomaly in the sample data.

2. The method of claim 1, wherein the sample data comprises a set of performance metrics and monitoring data for the datacenter.

3. The method of claim 1, wherein the normalized data is generated based on the mean and standard deviation of the sample data.

4. The method of claim 1, further comprising generating at least one vector based on the bin indices.

5. The method of claim 1, wherein the Gini coefficient is calculated based on the at least one vector.

6. The method of claim 1, wherein the Gini standard deviation dependent threshold is calculated using the standard deviation of the Gini coefficient over a series of sliding look-back windows.

7. The method of claim 1, further comprising aggregating bin indices for multiple nodes in the datacenter to form a vector representing sample data for the multiple nodes.

8. The method of claim 7, further comprising calculating a Gini coefficient based on the vector representing sample data for the multiple nodes.

9. The method of claim 1, further comprising aggregating Gini coefficients for multiple nodes to form an aggregated Gini coefficient.

10. The method of claim 1, further comprising sliding the look-back window to detect anomalies in sample data within the sliding window.

11. A system for detecting anomalies in a large scale and cloud datacenter, the system comprising:
a metrics collection module to collect metrics and monitoring data across the datacenter within a look-back window;
a statistical-based anomaly detection module for detecting anomalies in the collected data, the statistical-based anomaly detection module comprising:
a normalization module to generate normalized data from the collected data;
a binning module to place the normalized data into a plurality of bins defined by bin indices;
a Gini coefficient module to calculate a Gini coefficient for the look-back window;
a threshold module to calculate a Gini standard deviation dependent threshold; and
an anomaly alarm module to compare the Gini coefficient to the Gini standard deviation dependent threshold and generate an alarm when an anomaly in the collected data is detected; and
a dashboard module to display the look-back window and the detected anomalies.

12. The system of claim 11, wherein the metrics and monitoring data comprise service level metrics, system level metrics, and platform metrics.

13. The system of claim 11, wherein the normalization module generates normalized data based on the mean and standard deviation of the collected data.

14. The system of claim 11, wherein the binning module generates at least one vector based on the bin indices.

15. The system of claim 11, wherein the Gini coefficient is calculated based on the at least one vector.

16. The system of claim 11, wherein the Gini standard deviation dependent threshold is calculated using the standard deviation of the Gini coefficient over a series of sliding look-back windows.

17. The system of claim 11, further comprising an aggregation module to aggregate anomaly detection for multiple nodes in the datacenter.

18. A system for detecting anomalies in a large scale and cloud datacenter, the system comprising:
a metrics collection module to collect metrics and monitoring data across the datacenter within a look-back window;
a data quartile module to divide the collected data in quartiles;
a Tukey threshold module to generate adjustable thresholds; and
an anomaly alarm module to compare the collected data in the quartiles to the thresholds and generate an alarm when an anomaly in the collected data is detected.

19. The system of claim 18, wherein the adjustable thresholds comprise metric-dependent thresholds.

20. The system of claim 18, wherein the alarm is generated when the collected data in the quartiles is outside a range defined by the thresholds.
